(19) United States
(12) Patent Application Publication
(10) Pub. No.: US 2013/0087635 A1
(43) Pub. Date: Apr. 11, 2013

(54) AIR INLET DUCT FOR A TURBOJET NACELLE

(71) Applicants: Wouter Balk, Melun (FR); Pierre-Alain Jean-Marie Philippe Hugues Chouard, Melun (FR); Benoit Marc Michel Fauvelet, Bois le Roi (FR)

(72) Inventors: Wouter Balk, Melun (FR); Pierre-Alain Jean-Marie Philippe Hugues Chouard, Melun (FR); Benoit Marc Michel Fauvelet, Bois le Roi (FR)

(73) Assignee: SNECMA, Paris (FR)

(21) Appl. No.: 13/704,824

(22) PCT Filed: Jun. 15, 2011
(86) PCT No.: PCT/FR2011/051362

§ 371 Date: Dec. 17, 2012

(30) Foreign Application Priority Data
Jun. 18, 2010 (FR) 1054873

(51) Int. Cl. B64D 29/00

(52) U.S. Cl. CPC B64D 29/00
USPC 239/265.11

(57) ABSTRACT

An air inlet duct and method for producing such for a turbojet nacelle, the air inlet duct including an upstream annular lip and a downstream outer annular structure. The upstream annular lip and the downstream outer annular structure are formed as a one-piece part made from composite material and the upstream lip is covered with a metal layer formed by electro-deposition or plastic forming. A turbofan engine can include such an air inlet duct.

The invention relates to the field of aeronautics, and more particularly to an air inlet duct for a turbojet nacelle.

A nacelle which equips a turbojet is generally constituted by an assembly of approximately annular elements which are centered on an axis in the vicinity of the axis of the turbojet. From upstream toward downstream, the nacelle comprises in succession an air inlet duct, a fan cowling which surrounds the fan of the turbojet, as well as a rear part which constitutes a nozzle.

The air inlet duct of the nacelle makes it possible to supply the turbojet with a quantity of air which is sufficient to ensure that it functions in flight conditions. For this purpose, the air inlet duct comprises substantially:
an upstream annular lip, the aerodynamic profile of which is determined such as to capture enough air for the fan and the different compression stages; and
a downstream annular structure formed by an inner part which channels the incoming air toward the blades of the fan, and an outer part which assists travel which can minimize the drag along the nacelle.

From patent document FR 2 934 247 by the company SNECMA, it is known to produce an air inlet duct for a turbojet nacelle comprising an upstream lip which forms a leading edge, and a downstream structure, both annular, which are centered on a longitudinal axis of the nacelle, the downstream structure being connected at its respective upstream ends, to the lip, by securing means of the rivet type.

In that document, the downstream structure comprises two annular structures which form respectively inner and outer annular aerodynamic walls, arranged coaxially, one inside the other, around the longitudinal axis of the nacelle, and connected by their respective upstream ends to the lip. The downstream end of the outer structure also forms a peripheral envelope which extends radially, such as to isolate the air inlet duct from the compartment which is delimited by the cowling of the fan and the housings of the turbojet, and to introduce a mechanical connection, firstly with said downstream outer structure and secondly with the cowling of the fan.

The downstream annular structure is generally constituted by a composite material, which for example is reinforced by carbon fibers for reasons of lightness. The upstream annular lip, for its part, is constituted by a metal material, for example an aluminum alloy, in the form of three aluminum plates which are produced by means of plastic forming, and are connected to one another by splice pieces.

An air inlet duct of this type has several disadvantages. Firstly, the particular composition of the lip, in three parts (three aluminum plates) requires several operations. Secondly, since the size of the splice piece is substantially proportional to the longitudinal size of the plates formed, the travel of air at the level of these plates, and more particularly at the level of the splice piece, is subject to significant drag, since the presence of the splice piece precipitates the transition toward a turbulent limit layer. The longitudinal size of the plates is consequently limited, unless the splice piece is offset downstream in order to push back this transition.

In order to overcome these disadvantages, it is possible to produce the upstream annular lip also in composite material, or to produce the upstream lip and the downstream structure in a sole piece in a single part made of composite material.

However, in such a case, since the composite material is less rigid than the metal, it is necessary to provide a greater thickness of material in order to benefit from the same levels of rigidity and energy absorption, which ultimately makes the lip heavier than with metal. In fact, since the lip is liable to be subjected to impacts by birds or hailstones, it must be constituted by a material which can absorb the energy of an impact. However, because of their capacity to be deformed, in relation to their mass metals absorb more energy than composite materials. Consequently, a lip made of composite material, with the same resistance to impact, would be heavier than its equivalent made of aluminum.

In addition, the lip generally serves the purpose of defrosting the air inlet, with hot air obtained from the engine being conveyed to the lip in order to prevent the accumulation of ice on it. However, a lip made of metal is more resistant to high temperatures than a lip made of composite material.

The object of the invention is to eliminate these disadvantages, and for this purpose it proposes an air inlet duct for a turbojet nacelle, comprising an upstream annular lip and a downstream annular outer structure, characterized in that said upstream annular lip and said downstream annular outer structure are formed in a single piece made of composite material, and in that said upstream lip (13) is covered by a metal layer which is formed in particular by electro-deposition or by plastic forming.

By means of the invention, an air inlet duct is obtained, the lip of which can be made of a composite material.

In addition, the metal layer thus deposited or formed provides better resistance to erosion than a composite material, whilst having a better aesthetic appearance. The resistance to impact is also improved by the metal layer, for impacts by birds or hailstones. It will be noted however that for impacts of a greater scale (of the type such as the loss of a blade), it is important to have a sufficient thickness of layer, which therefore does not necessarily make it possible to reduce the total thickness of the lip.

In addition, since the part which forms the upstream lip and the downstream outer structure is in a single piece, the invention makes it unnecessary to have splice pieces, thus making it possible to have a perfectly regular cross-section which does not disrupt the aerodynamic flow of the outer side.

It will also be noted that the fact that the sector of the duct made in a single piece comprising the upstream annular lip and the downstream annular outer structure makes it possible to obtain a part in a single piece with the largest possible size, thus preventing any step in the thickness along the outer part of the duct and also improving the aerodynamic behavior.

Finally, it will be noted that the part in a single piece is made of a composite material, for example with carbon, which makes it possible to produce easily a lip in a single piece which is circumferential, without needing to sectorize the lip (although it is still possible to sectorize it).

According to an advantageous embodiment, the metal layer covers the upstream annular lip and the upstream end of the downstream annular outer structure. This therefore prevents any aerodynamic deficiency, since the part in a single piece does not have any step in its thickness.

According to another particular embodiment, the part in a single piece made of composite material is provided with a bay, which makes it possible to prevent the transition between the metal and the composite material from generating a step in the thickness.

According to an advantageous embodiment, the metal layer covers the upstream end of the duct uniformly, which makes it possible to prevent all the better any aerodynamic deficiency at the level of the outer wall of the air inlet duct.

According to another particular embodiment, the metal layer is slightly embedded in the composite material, in order to prevent any step in the thickness.

If the air inlet duct according to the invention also comprises a downstream annular inner structure, the sector of said duct made in a single piece comprises at least part of the inner structure. The duct can thus be made in a sole part in a single piece, which saves carrying out a certain number of time-consuming operations. It will be noted however that it is the outer part of the air inlet duct which is most important, since it is the place where the aerodynamic performance is most likely to be impaired.

According to different embodiments, the part in a single piece is formed by a sole annular part in a single piece (around 360°) or by two, semi-annular parts in a single piece (around 180°).

According to an advantageous embodiment, the downstream end of the downstream annular outer structure forms the peripheral envelope of the nacelle, which makes it possible to limit the number of time-consuming operations of riveting of the peripheral partition onto the inner and outer walls of the downstream structure, these operations being carried out on a single part in a single piece.

Preferably, the metal layer comprises titanium, this material having particularly satisfactory resistance to erosion and to impact.

The invention also relates to a dual-flow turbojet, the air inlet duct of which is formed according to one of the above-described embodiments.

The invention also relates to a process for production of an air inlet duct for a turbojet nacelle, comprising an upstream annular lip and a downstream annular outer structure, which process is characterized in that:
said upstream annular lip and said downstream annular outer structure are formed in a single piece made of composite material; and
a metal layer, formed in particular by electro-deposition or by plastic forming, is glued onto said upstream lip.

The invention will be better understood by means of the attached drawing, in which:

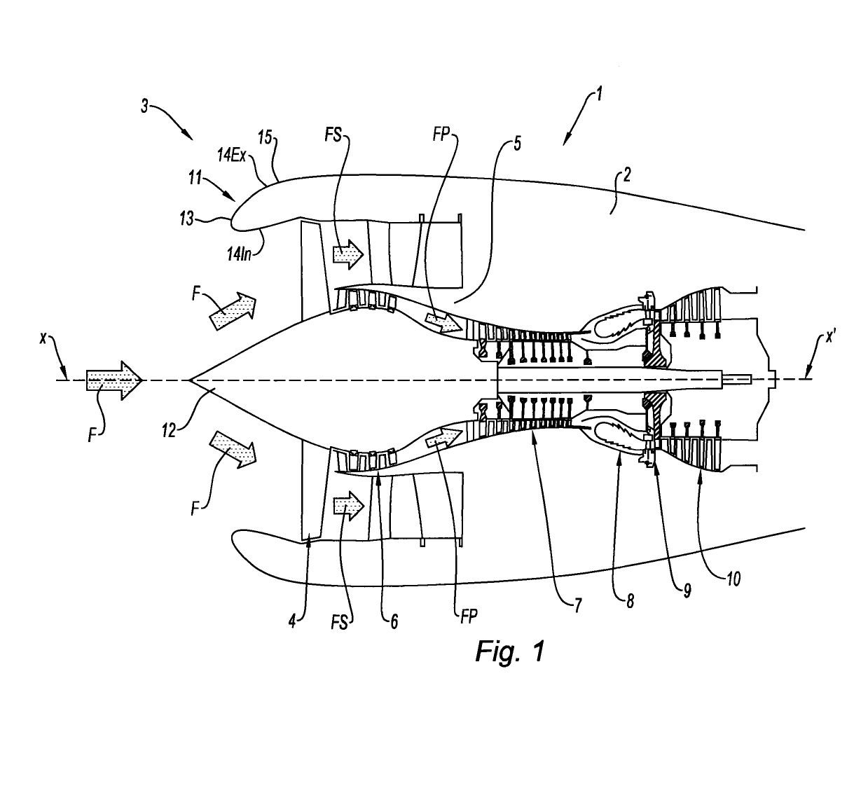

FIG. 1 is a schematic view in longitudinal cross-section of a dual-flow turbojet, the air inlet duct of which is formed according to the invention;

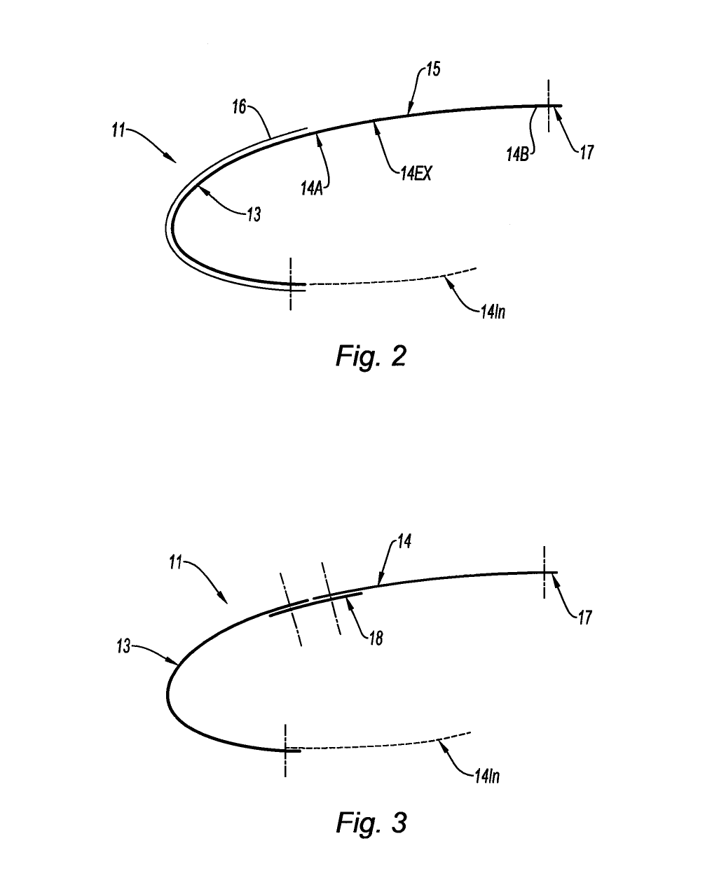

FIG. 2 is an enlarged view of the air inlet duct of the turbojet in FIG. 1; and

FIG. 3 is a view of an air inlet duct according to the prior art, by way of comparison.

For better legibility of the figures, identical numerical references will designate similar technical elements.

The turbojet 1 in FIG. 1 is of the dual-flow and double-body type, with symmetry of revolution around an axis X-X′. In a known manner, this turbojet 1 comprises, inside a nacelle 2 which acts as an envelope for its different units, an air inlet 3 via which an incoming flow of air F can penetrate, in order then to pass through an inlet fan 4. This flow of air F is then separated into two flows, respectively a primary flow FP and a secondary flow FS, via an intermediate housing 5, the end of which forms a separator spout.

Hereinafter in the description, the terms “upstream” and “downstream” relate to axial positions along the longitudinal axis X-X′, in the direction of travel of the flow of air in the turbojet 1.

The secondary flow FS passes through a rectifier stage, in order then to be discharged downstream of the turbojet. The primary flow FP passes in succession through a low-pressure compression stage 6, a high-pressure compression stage 7, a combustion chamber 8, a high-pressure turbine stage 9 and a low-pressure turbine stage 10, in order finally to be discharged from the turbojet through a nozzle (with no reference).

The nacelle 2 of this turbojet is annular and is arranged at least approximately coaxially around the longitudinal axis X-X′. It makes it possible to channel the gaseous flows generated by the turbojet by defining outer and inner aerodynamic travel lines for gaseous flows.

The air inlet 3, the axis of which is in the vicinity of the axis X-X′ of revolution of the turbojet 1, comprises an air inlet duct 11, as well as an air inlet cone 12. The latter permits aerodynamic guiding and distribution of the total flow F around the axis X-X′.

The air inlet duct 11 of the nacelle defines the upstream opening of the turbojet 1, with its inner aerodynamic surface forming the upstream outer envelope of the air stream inside the turbojet 1.

This air inlet duct 11 comprises:
an upstream annular lip 13 which forms a leading edge, the aerodynamic profile of the lip being designed to make it possible to capture in an optimum manner the air necessary for the inlet fan 4 and for the compressors 6 and 7;
a downstream annular structure 14 in the form of a barrel, this structure 14 being designed to channel the incoming air toward the blades of the fan 4.

With reference to FIG. 1, the annular downstream structure 14 comprises a first downstream annular outer structure 14Ex and a second downstream annular inner structure 14In, which form two respectively outer 14Ex and inner 14In annular aerodynamic walls relative to the turbojet, these two walls being arranged at least approximately coaxially one inside the other around the longitudinal axis X-X′ of the nacelle. These structures 14Ex and 14In adjoin the downstream end of the annular lip 13 (in particular the upstream ends 14A of the outer structure 14Ex in FIG. 2).

More particularly, with reference to FIG. 2 which represents specifically the air inlet duct 11 of the turbojet 1 in FIG. 1, said duct 11 is produced in a single part in a single piece 15, which includes both the lip 13 and the outer downstream structure 14Ex.

The inner downstream structure 14In (represented as a broken line in FIG. 2) of the duct, for its part, does not form part of the part in a single piece 15. A splice piece is provided between the inner downstream edge of the lip 13, and the wall of the structure 14In, in order to assemble it to the part 15. According to another variant embodiment, the part in a single piece can also include this inner downstream structure 14In.

According to different variants, the duct 11 can thus be produced in a sole annular part in a single piece 15 around 360°, or in two parts in a single piece in the form of sectors which extend around 180°, or of any number of sectors, provided that their assembly can make up the equivalent of an annular part around 360°. However, persons skilled in the art will note that it is preferable for the duct 11 to be produced in a sole annular part in a single piece around 360°, which makes it possible to avoid connecting several parts mechanically, for example by means of rivets which can create surface discontinuities at the level of the duct, and therefore impair the aerodynamic performance of the device.

This part 15, or each of the parts assembled to form the equivalent of this part, is/are made of reinforced composite material, for example with carbon fibers, which provides the nacelle with a certain lightness.

According to the invention, the upstream lip 13, and optionally an upstream part of the downstream outer structure 14Ex, is covered with a metal layer 16, formed for example by titanium, for the purpose firstly of reinforcing the resistance to oxidation and corrosion, as well as the resistance to impact of said lip, and secondly optionally to improve its cosmetic performance.

In order to produce this layer, electro-deposition is carried out, i.e. a process which persons skilled in the art will know how to implement.

More precisely, the electro-deposition process can consist of carrying out the following steps:
a mold, with the same shape as the part on which a layer of metal is to be applied is immersed in a nickel sulfamate solution;
an electric current is applied to the mold;
a layer of nickel is deposited on the mold;
the layer of nickel is separated from the mold;
the layer of nickel is transferred onto the part made of composite material;
the metal layer is glued onto the composite part, by means of adhesive.

According to other variants of implementation of this electro-deposition process, it is possible to use other metals, such as titanium.

According to another variant embodiment of the electro-deposition process, it is possible to immerse the upstream end of the part 15 in a vessel, for example in the form of a parallelepiped, containing a bath of metal electro-deposition liquid to be deposited.

The bath in question is a titanium bath, but use can be made of other types of baths, depending on the applications envisaged, for example a platinum bath (Pt²⁺, Pt⁴⁺ ions), to which additives are added, for the purpose of depositing a coating of titanium on the part 15, by means of the passage of electric current which is obtained from a current generator, and circulates between respective anode and cathode electrodes immersed in the bath.

In order to control certain physical characteristics of the metal electro-deposition bath (containing in particular the metal elements and additives) and more particularly, but not exclusively, the thickness of the metal coating deposited and the external appearance and gloss of the coating, it is possible to use two, respectively anode and cathode, electrodes which are immersed in the bath, and a current generator which connects the electrodes. This type of control device, which is generally known as a Hull cell, is described extensively in patent document U.S. Pat. No. 2,149,344.

According to another embodiment of the invention, in order to cover the upstream lip 13 with a metal layer, use can be made of another process of depositing by plastic forming, also known to persons skilled in the art. The thinned plate thus formed by plastic forming can then be glued directly onto the lip 13.

Depending on the applications envisaged, use can be made of one or the other of the processes in order to cover the lip 13 with a metal layer. In particular, immersing the part itself into the bath can be avoided, in that this is liable to impair the mechanical characteristics of the fibers, and impair the electrical conductivity of the organic resin which bonds said fibers.

In the present embodiment, the end 14B of the downstream outer structure 14Ex is designed to be extended, such as to form directly the peripheral envelope 17 of the nacelle 2, which improves accordingly the performance of said nacelle from the aerodynamic point of view, since the latter does not have on its surface any securing means (for example rivets) which can introduce discontinuities into the aerodynamic travel in the vicinity of the nacelle.

It will be noted here that it is possible to form only the upstream lip 13 and the downstream outer structure 14Ex in a sole part in a single piece 15, since the downstream inner structure 14In can incorporate an acoustic treatment means. However, it is preferable for the largest part possible of the air inlet duct 11 to be made of composite material, since this simplifies the operations of production and integration of the duct.

It will also be noted that it is possible to cover only a sector of ring of the upstream end of the duct with the metal layer.

By way of comparison, FIG. 3 shows an air inlet duct according to the prior art, wherein the annular lip 13 and the annular downstream structure 14 are two distinct parts which are connected mechanically, for example by means of an annular splice piece 18, this splice piece 18 being connected to the lip 13 and the structure 14 by a plurality of rivets (not represented) which are regularly distributed around the longitudinal axis X-X′. In this type of embodiment it is found that there is a risk of discontinuity of the outer surface of the air inlet duct, which is a source of low aerodynamic performance.

The invention has been described above for formation of the metal layer 16 by electro-deposition or plastic forming, but it will be appreciated that persons skilled in the art will know how to adapt the invention to other means for production of said metal layer, provided that said metal layer can cover the upstream end of the duct 11.

1-9. (canceled)

10. An air inlet duct for a turbojet nacelle, comprising:
an upstream annular lip; and
a downstream annular outer structure;
wherein a part of the duct including the upstream annular lip and the downstream annular outer structure is formed in a single piece made of composite material, and
wherein the upstream lip is covered by a metal layer formed by electro-deposition or by plastic forming.

11. The duct as claimed in claim 10, wherein the metal layer covers the upstream lip and the upstream end of the downstream annular outer structure.

12. The duct as claimed in claim 10, wherein the metal layer covers the upstream end of the duct uniformly.

13. The duct as claimed in claim 10, further comprising:
a downstream annular inner structure, and the part of the duct formed in a single piece comprises at least part of the inner structure.

14. The duct as claimed in claim 10, wherein the part of the duct formed in a single piece is formed by a sole annular part in a single piece.

15. The duct as claimed in claim 10, wherein the downstream end of the downstream annular outer structure forms a peripheral envelope of the nacelle.

16. The duct as claimed in one of the preceding claim 10, wherein the metal layer comprises titanium.

17. A dual-flow turbojet comprising an air inlet duct formed according to claim 10.

18. A process for production of an air inlet duct for a turbojet nacelle, including an upstream annular lip and a downstream annular outer structure, the process comprising:
forming the upstream annular lip and the downstream annular outer structure in a single piece made of composite material; and
gluing a metal layer, formed by electro-deposition or by plastic forming, onto the upstream lip.
